(19) United States
(12) Patent Application Publication
(10) Pub. No.: US 2021/0027104 A1
(43) Pub. Date: Jan. 28, 2021

(54) EYES-OFF ANNOTATED DATA COLLECTION FRAMEWORK FOR ELECTRONIC MESSAGING PLATFORMS

(71) Applicant: Microsoft Technology Licensing, LLC, Richmond, WA (US)

(72) Inventors: Saurabh SHRIVASTAVA, Hyderabad (IN); Rajath Kumar RAVI, Hyderabad (IN); Saheel Ram GODHANE, Hyderabad (IN); Prateek AGRAWAL, Hyderabad (IN); Manvendra Pramendra KUMAR, Hyderabad (IN); Bikash Ranjan SWAIN, Hyderabad (IN); T Guru Pradeep REDDY, Hyderabad (IN)

(21) Appl. No.: 16/521,982

(22) Filed: Jul. 25, 2019

(51) Int. Cl. G06K 9/62; H04L 12/58; G06N 20/00

(52) U.S. Cl. CPC G06K 9/6257; G06K 9/6231; G06N 20/00; H04L 51/046

(57) ABSTRACT

Systems and methods for annotated data collection in an electronic messaging platform. One example system includes a machine learning database and an electronic processor communicatively coupled to the machine learning database. The electronic processor is configured to receive a plurality of electronic messages. The electronic processor is configured to select a sample message set from the plurality of electronic messages. The electronic processor is configured to add an actionable message to each electronic message of the sample message set. The electronic processor is configured to receive an actionable message selection from an electronic messaging client. The actionable message selection includes a user label indication and a message identifier. The electronic processor is configured to store the actionable message selection in the machine learning database.

### FIELD

Embodiments described herein relate to training machine learning models and, more particularly, to systems and methods for eyes-off annotated data collection in an electronic messaging platform.

### SUMMARY

Machine learning models are used to enhance, among other things, electronic messaging systems and other content delivery networks. Machine learning models provide insights and actions to improve user experience and productivity. For example, machine learning allows email systems to automatically perform keyword tagging in attachments; detect spam, fishing, and other types of unwanted or harmful messages; set sensitivity levels of email messages; identify message topics; identify message importance; identify message tone; and the like. The effectiveness of these machine learning models depends on, among other things, the accuracy of the training set's classification for supervised learning techniques. For example, in Bayesian spam filtering the algorithm is manually taught the differences between spam and non-spam. The effectiveness of the filtering depends on the ground truth of the messages used to train the algorithm. Inaccuracies in the ground truth leads to inaccuracies in the results of the machine learning model.

The ideal training data for an organization's email system is the emails produced by users of that system. However, data privacy concerns and other considerations do not allow this data to be manually inspected by others outside the organization. Sources of publically available email data (for example, the Enron public email archive and the Avocado public email archive) exist for use in training machine learning models. However, there are several disadvantages to using these archives. Manual classification of the emails across multiple models and organizations is time consuming and costly. The archives are specific to their user bases and may not be directly applicable to another organization. In addition, communication styles and conventions evolve over time, and the available archives are aging and fixed in time.

Accordingly, to generate useful training data for multiple organizations while maintaining data security, embodiments described herein leverage user inputs to generate ground truth for an organization's machine learning models employing the organization's data. Embodiments described herein selectively present an organization's users with possible labels for email messages. User-selected labels are used to reinforce existing machine learning models. Using the embodiments presented herein, annotated training data sets are generated in an eyes-off fashion (that is, without the use of outside human annotators). The resulting training data sets uses data specific to the organization without exposing the data to parties outside the organization. Such embodiments enable multiple partners to use a common messaging platform with individually customized machine learning models, which are specific to their respective organizations and compliant with applicable data security and privacy regulations

Using the embodiments presented herein, machine learning models are able to produce more accurate results, improving the user experience. Embodiments described herein therefore result in more efficient use of computing system resources, and the improved operation of electronic messaging and other computing systems for users.

In particular, one embodiment provides a system for annotated data collection in an electronic messaging platform. The system includes a machine learning database and an electronic processor communicatively coupled to the machine learning database. The electronic processor is configured to receive a plurality of electronic messages. The electronic processor is configured to select a sample message set from the plurality of electronic messages. The electronic processor is configured to add an actionable message to each electronic message of the sample message set. The electronic processor is configured to receive an actionable message selection from an electronic messaging client. The actionable message selection includes a user label indication and a message identifier. The electronic processor is configured to store the actionable message selection in the machine learning database.

Another embodiment provides a method for annotated data collection in an electronic messaging platform. The method includes receiving a plurality of electronic messages. The method includes selecting, with an electronic processor, a plurality of qualified electronic messages from the plurality of electronic messages based on at least one qualifier. The method includes selecting, with the electronic processor, a sample message set from the plurality of qualified electronic messages. The method includes adding an actionable message to each electronic message of the sample message set. The method includes receiving an actionable message selection from an electronic messaging client. The actionable message selection includes a user label indication and a message identifier. The method includes storing the actionable message selection in a machine learning database communicatively coupled to the electronic messaging platform.

Yet another embodiment provides a non-transitory computer-readable medium including instructions executable by an electronic processor to perform a set of functions. The set of functions includes receiving a plurality of electronic messages. The set of functions includes selecting a plurality of qualified electronic messages from the plurality of electronic messages based on at least one qualifier. The set of functions includes selecting a sample message set from the plurality of qualified electronic messages. The set of functions includes adding an actionable message to each electronic message of the sample message set. The set of functions includes receiving an actionable message selection from an electronic messaging client, the actionable message selection including a user label indication and a message identifier. The set of functions includes storing the actionable message selection in a machine learning database communicatively coupled to the electronic messaging platform.

### BRIEF DESCRIPTION OF THE DRAWINGS

FIG. 1 schematically illustrates a system for annotated data collection in an electronic messaging platform, according to some embodiments.

FIG. 2 schematically illustrates an electronic messaging server, according to some embodiments.

FIG. 3 is a flowchart illustrating a method performed by the system of FIG. 1 for annotated data collection in an electronic messaging platform, according to some embodiments.

FIG. 4 is an example email message stamped with an actionable message using the method of FIG. 3, according to some embodiments.

FIG. 5 is an example email message stamped with an actionable message using the method of FIG. 3, according to some embodiments.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way, but may also be configured in ways that are not listed. Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

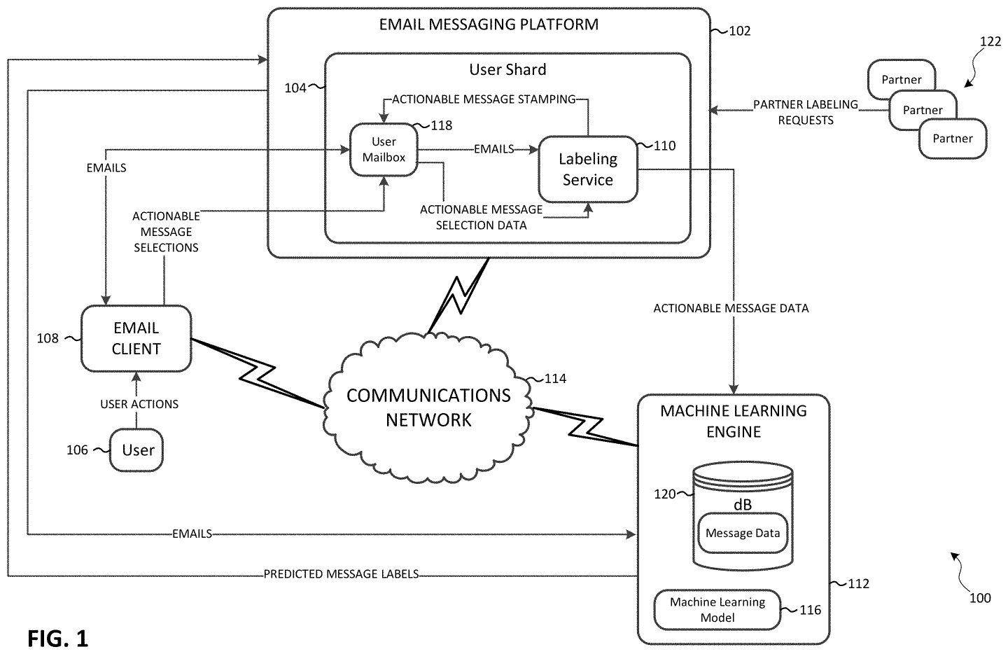

FIG. 1 illustrates an example system 100 for automatic annotated data collection in an electronic messaging platform 102. As an example, the electronic messaging platform 102 is illustrated as an email messaging platform, which includes a user shard 104 that provides email messaging services to a user 106 via an email client 108. For ease of description, the example electronic messaging platform 102 is illustrated with a single user shard 104 providing emails services for a single email client 108. It should be understood that embodiments of the electronic messaging platform 102 may include multiple user shards for serving tens, hundreds, or thousands of users and email clients. Embodiments of the electronic messaging platform 102 may provide, in addition to or in place of email, other forms of electronic messaging or content delivery for users.

As illustrated in FIG. 1, the system 100 includes a labeling service 110 and machine learning engine 112. It should be understood that the system 100 is provided as one example and, in some embodiments, the system 100 may include fewer or additional components. For example, the system 100 may include multiple labeling services, multiple machine learning engines, electronic messaging platforms, or combinations thereof.

The electronic messaging platform 102, the email client 108, the machine learning engine 112, and other illustrated components are communicatively coupled via a communications network 114. The communications network 114 may be implemented using a wide area network (e.g., the Internet), a local area network (e.g., an Ethernet or Wi-Fi™ network), a cellular data network (e.g., a Long Term Evolution (LTE™) network), and combinations or derivatives thereof.

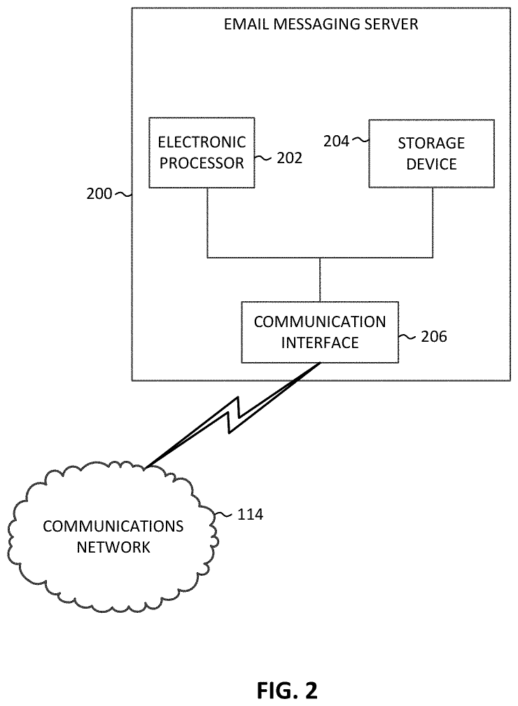

In some embodiments, the electronic messaging platform 102 is implemented with a computing environment that includes an email messaging server 200 (schematically illustrated in FIG. 2). As illustrated in FIG. 2, the email messaging server 200 includes an electronic processor 202 (for example, a microprocessor, application-specific integrated circuit (ASIC), or another suitable electronic device), a storage device 204 (for example, a non-transitory, computer-readable storage medium), and a communication interface 206, such as a transceiver, for communicating over the communications network 114 and, optionally, one or more additional communication networks or connections. It should be understood that the email messaging server 200 may include additional components than those illustrated in FIG. 2 in various configurations and may perform additional functionality than the functionality described in the present application. Also, it should be understood that the functionality described herein as being performed by the email messaging server 200 may be distributed among multiple devices, such as multiple servers and may be provided through a cloud computing platform, accessible by components of the system 100 via the communications network 114.

The electronic processor 202, the storage device 204, and the communication interface 206 included in the email messaging server 200 are communicatively coupled over one or more communication lines or buses, or combination thereof. The electronic processor 202 is configured to retrieve from the storage device 204 and execute, among other things, software to perform the methods described herein (for example, the labeling service 110).

Returning to FIG. 1, the email client 108, the labeling service 110, and the machine learning engine 112 exchange information via the communications network 114, and operate to automatically annotate and collect data to train a machine learning model 116. The machine learning model 116 provides intelligent insights to users of the electronic messaging platform 102, as noted herein. The electronic messaging platform 102 operates to provide users (for example, the user 106) with electronic messaging services remotely, via one or more networks. In some embodiments, the electronic messaging platform 102 operates on a Microsoft Office 365® platform. In some embodiments, the electronic messaging platform 102 provides other content delivery services, such as the OneDrive® and SharePoint® platforms produced by Microsoft.

In the illustrated example, the electronic messaging platform 102 provides a user shard 104. The user shard 104 is a discrete computing instance accessible by an individual user (for example, the user 106). The user 106 interacts with the email client 108 (for example, a Microsoft Outlook® client) to send and receive emails (for example, stored in the user mailbox 118. As described in detail herein, the labeling service 110 analyzes emails from the user mailbox 118 (prior to those emails being presented to the email client 108) and selectively stamps the emails with actionable messages. Actionable messages are presented when the user opens an email, and request that the user provide feedback on the email. For example, the actionable message may ask the user to select a label that applies to the email (for example, “important” or “not important”). When the user 106 views the emails with the email client 108, the actionable messages are selectively presented to the user 106. As described in detail herein, the user 106 interacts with the actionable messages to generate actionable message selections (including the user feedback), which are stored in the user mailbox 118 and transmitted to the labeling service 110 for processing. The labeling service 110 transmits data from the actionable message selections in the machine learning engine 112 for processing and storage.

In some embodiments, the machine learning engine 112 is a network-attached and accessible computer server that includes similar components as the email messaging server 200. The machine learning engine 112 includes a database 120. The database 120 electronically stores information relating to the email messages and the actionable message data received from the labeling service 110. In the embodiment illustrated, the database 120 is locally stored on the machine learning engine 112. In alternative embodiments, the database 120 is a database housed on a suitable database server communicatively coupled to and accessible by the machine learning engine 112 and the labeling service 110. In some embodiments, the database 120 is part of a cloud-based database system external to the system 100 and accessible by the machine learning engine 112 and the labeling service 110 over one or more additional networks.

In some embodiments, as illustrated in FIG. 1, the database 120 electronically stores or accesses message data. The message data includes message content, message labels, message metadata, message user data and metadata, inferred data for the messages, and in-context data for the messages. The message data also includes the actionable message selection data, as provided by the labeling service 110.

The machine learning engine 112 uses various machine learning methods to analyze email messages for users of the email messaging platform and apply predicted message labels. For example, the machine learning engine 112 executes the machine learning model 116 to automatically label emails for the user mailbox 118. Automatic labeling may include identifying the importance of an email message, identifying the tone of an email message to be sent (for example, whether a message could be interpreted as overly harsh in nature), identifying potential spam messages, identifying the topic of an email message, and the like. Machine learning generally refers to the ability of a computer program to learn without being explicitly programmed. In some embodiments, a computer program (for example, a learning engine) is configured to construct an algorithm based on inputs. Supervised learning involves presenting a computer program with example inputs and their desired outputs. The computer program is configured to learn a general rule that maps the inputs to the outputs from the training data it receives. Example machine learning engines include decision tree learning, association rule learning, artificial neural networks, classifiers, inductive logic programming, support vector machines, clustering, Bayesian networks, reinforcement learning, representation learning, similarity and metric learning, sparse dictionary learning, and genetic algorithms. Using all of these approaches, a computer program can ingest, parse, and understand data and progressively refine algorithms for data analytics.

In the example illustrated, the machine learning engine 112 includes a single machine learning model 116. However, embodiments of the machine learning engine 112 include multiple machine learning models to provide automated email analysis for multiple types of labels, multiple users, or both. In some embodiments, the machine learning engine 112 may be independent of the system 100 and operated, for example, by a partner 122, and accessible by components of the system 100 over one or more intervening communication networks.

In some embodiments, the system 100 and the electronic messaging platform 102 may be used by one or more partners 122. A partner 122 is a group of users, for example, an organization or a division within an organization. Embodiments of the system 100 operate to receive partner labeling requests from the partners 122. As described in detail herein, a partner labeling request includes data and parameters used to establish one or more machine learning models used to analyze messages for users of the partner 122. In some embodiments, the partner labeling request is received as part of onboarding the partner to the electronic messaging platform 102. In some embodiments, the partner labeling request includes an initial machine learning model, which is transmitted to the machine learning engine 112 for execution and training, as described herein. In some embodiments, the partner labeling request includes a request to display a particular actionable message irrespective of an email's qualification.

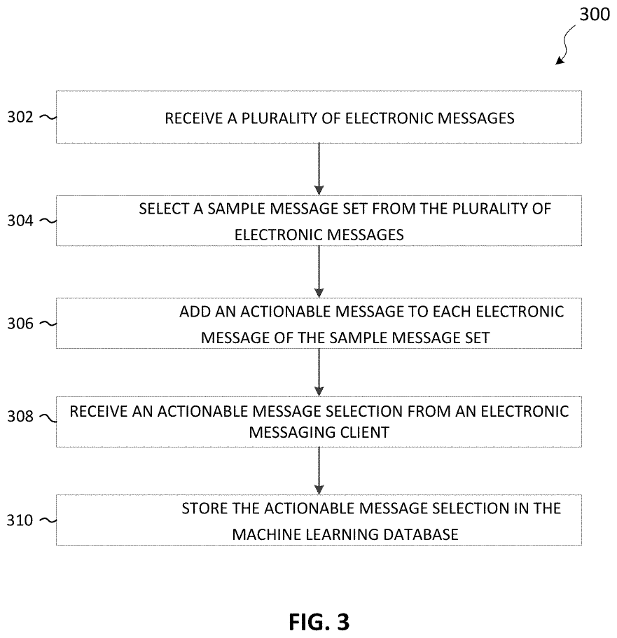

FIG. 3 illustrates an example method 300 for annotated data collection in an electronic messaging platform. The method 300 is described as being performed by the system 100, and, in particular, the labeling service 110 as executed by the electronic processor 202. However, it should be understood that in some embodiments, portions of the method 300 may be performed by other devices, including for example, the machine learning engine 112 and the email client 108. As an example, the method 300 is described in terms of the labeling service 110 and other components operating to collect sample data for a single electronic messaging platform 102. However, it should be understood that embodiments of the method 300 may be used with multiple quantities and types of messaging platforms arranged in various combinations. It should also be understood that embodiments of the method 300 may be used by embodiments of the system 100 that include more than one user shard 104 or machine learning engine 112.

At block 302, the electronic processor 202 receives a plurality of electronic messages. For example, the electronic processor 202 monitors the user mailbox 118 for email messages that are delivered to the user mailbox 118 for the user 106, or sent to the user mailbox 118 via the email client 108 for delivery to other users. Prior to allowing the email client 108 access to delivered messages, or forwarding sent messages, the labeling service processes the emails for actionable message stamping.

For example, at block 304, the electronic processor 202 selects a sample message set from the plurality of electronic messages. The sample message set includes a subset of the plurality of electronic messages, which may be selected by a number of means. In some embodiments, the electronic processor 202 selects the sample message set by selecting a random sample from the plurality of electronic messages. For example, the electronic processor 202 may randomly select 10% of all messages for the sample message set.

In some embodiments, the labeling service 110 keeps a running total of the number of email messages that have been stamped with actionable messages. In some embodiments, the electronic processor 202 selects the sample message set based on the running total of stamped messages. For example, there may be a desired number of messages for training a particular machine learning model. On a first come, first served basis, the electronic processor 202 selects email messages until a sufficient number have been selected, upon which the electronic processor stops selecting email messages for the sample set. In such embodiments, the electronic processor 202 may, for example, resume selecting sample messages when analysis of the machine learning model indicate that more training is needed.

In some embodiments, the electronic processor 202 selects every email message for inclusion in the sample message set. In such embodiments, the electronic processor 202 adds an actionable message to all electronic messages, and controls the display of the actionable message to the user 106 (for example, using the email client 108. In some embodiments, the labeling service 110 may collect sample messages by displaying a certain number of actionable messages, regardless of how many are acted upon by users. This may be done for example, to avoid oversaturating a user base with requests for message analysis. For example, the electronic processor 202 may display the actionable message to a user of the electronic message when a total number of actionable messages presented does not exceed a desired sample number (the total number of actionable messages displayed to users, regardless of user selection).

In some embodiments, the labeling service 110 may collect sample messages by displaying actionable messages until it receives a sufficient amount of user feedback to train the machine learning model. For example, the electronic processor 202 displays the actionable message to a user of the electronic message when a total number of received actionable message selections does not exceed a desired collection number (the total number of actionable message selections desired).

In some embodiments, prior to selecting the sample set, the electronic processor 202 selects, from the plurality of electronic messages, a plurality of qualified electronic messages based on at least one qualifier. In such embodiments, the electronic processor 202 selects the sample message set from the plurality of qualified electronic messages. A qualifier is a criterion used to select messages for inclusion in (or exclusion from) the sample set. For example, where the machine learning model is used to determine the importance of a message, the qualifier may be based on the user's rank within an organization. In another example, only certain user sets within an organization may be selected to distribute the load, or to achieve an even distribution of user types. In some embodiments, predicted labels for the messages (generated by the current iteration of the machine learning model) are used to qualify messages for inclusion in the sample set. For example, messages that are labeled with a very high confidence level (for example, 90%) may be excluded from the sample set, so that user data will be collected on the messages that are presently more difficult to classify. By only qualifying such messages, users are not bothered to supply feedback for easy cases, and the machine learning model is provided with more useful training data.

Presenting users with requests for feedback too often may result in diminishing returns. Accordingly, in some embodiments, for each electronic message of the sample message set, the electronic processor 202 compares a time period since an actionable message was last presented to a recipient of the electronic message to a time gap enforcement threshold (for example, 1 week). When the time period does not exceed the time gap enforcement threshold, the electronic processor 202 removes the electronic message from the sample message set. In this example, the recipient would not be asked to provide feedback on a message if the user had provided feedback in the previous week. This encourages user participation, in that users know that if the provide feedback, they will not be asked to do so again for at least a week.

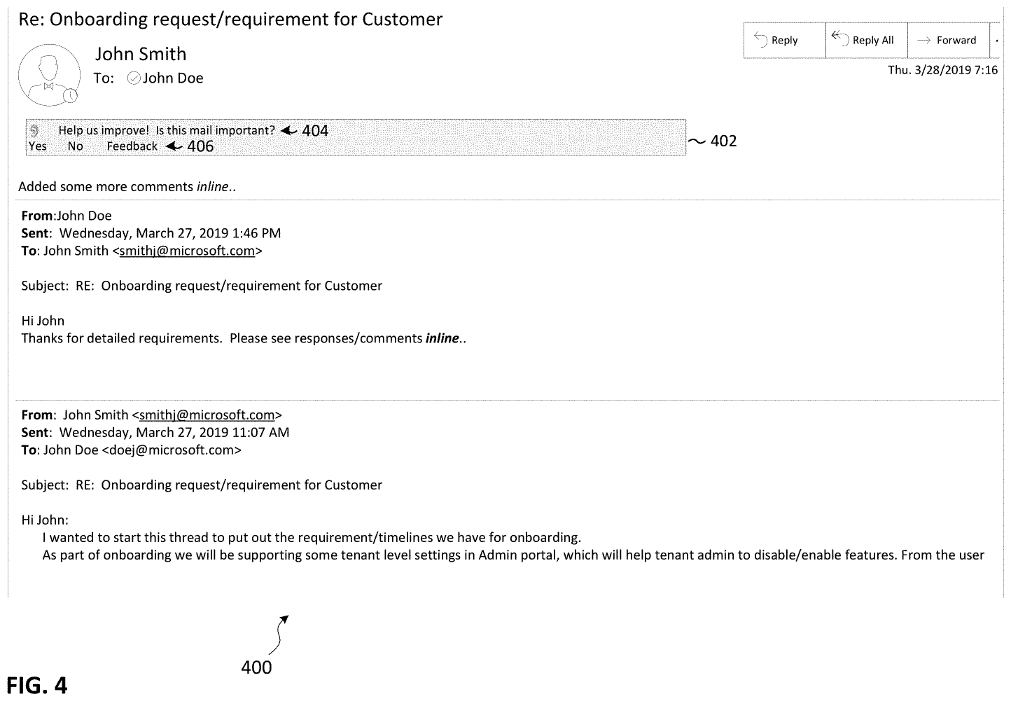

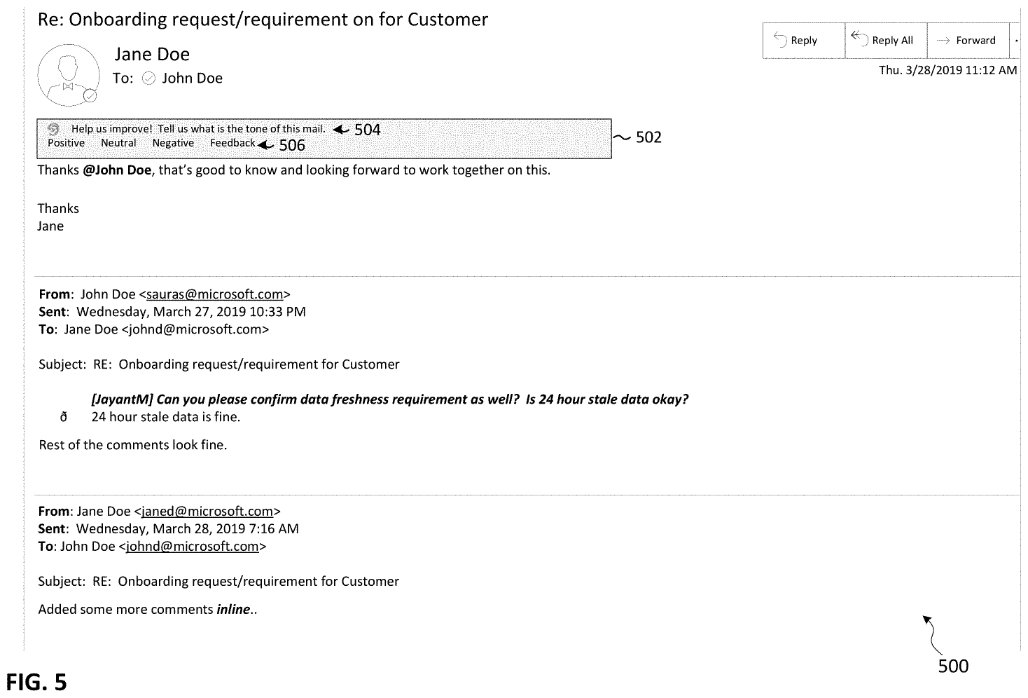

Regardless of how the sample message set is selected, at block 306, the electronic processor 202 adds an actionable message to each electronic message of the sample message set. For example, the actionable message (including a nudge message and one or more possible labels for the message) is added to the header of the email message. When opened by the user, the actionable message will appear as an InfoBar nudge and ask for a specific label for the email message. For example, FIG. 4 illustrates an email message 400, including an example actionable message 402. The actionable message 402 includes a nudge message 404 and possible labels 406. In another example, FIG. 5 illustrates an email message 500, including an example actionable message 502. The actionable message 502 includes a nudge message 405 and possible labels 506.

In some embodiments, the electronic processor 202 receives a partner labeling request that includes the nudge message, one or more possible message labels, and one or more qualifiers (used to generate the plurality of qualified electronic messages, as described herein).

In some embodiments, multiple machine learning models may be in use, and a different type of actionable message (requesting different labels) is used for each machine learning model. In such embodiments, the electronic processor 202 may stamp messages with the actionable message types on a round robin basis.

The stamped email messages are delivered to the user mailbox 118, and accessed by the user 106, for example, using the email client 108. When the user interacts with the actionable message, selecting a label, the actionable message selection is stores in the user mailbox 118 and transmitted to the labeling service 110.

At block 308, the electronic processor 202 receives an actionable message selection from an electronic messaging client (for example, the email client 108). The actionable message selection includes a user label indication and a message identifier. The user label identification indicates the label selected by the user, and the message identifier uniquely identifies the email within the electronic messaging platform 102. In some embodiments, the actionable message selection also includes additional data (for example, data identifying the user, context data, and the like).

Many email messages are sent to more than one person, in which case multiple users may provide actionable message selections for the same message. In some embodiments, the electronic processor 202 receives a plurality of actionable message selections associated with a single message identifier. In order to provide clean training data to the machine learning engine 112, the labeling service 110 determines an aggregate label associated with the single message identifier. For example, the electronic processor 202 may apply a majority function to the received labels.

At block 310, the electronic processor 202 stores the actionable message selection in the machine learning database. Once stored in the machine learning database, the labels and message data are used by the machine learning engine 112 to train and improve the machine learning model 116. As noted herein, the machine learning engine 112 may implement multiple machine learning models for multiple partners. In such embodiments, the actionable message selection data for each partner is stored separately in separate data sources dedicated to each partner. One partner's data is not used to train another partner's machine learning model.

In some embodiments, the labeling service 110 estimates the quality of the predicted labels. For example, the electronic processor 202 receives, from the machine learning engine 112, a predicted label associated with a message identifier. The electronic processor 202 retrieves, from the machine learning database 120, the user label indication from the actionable message selection associated with the message identifier. The electronic processor 202 then compares the predicted label to the user label indication to generate a label quality level. In some embodiments, predicted labels are compared to user-supplied labels over time as the model is iterated to generate a rolling average quality level. This allows the labeling service 110 to continually gauge the success of the machine learning model training without having third parties review the underlying partner data. This maintains the confidentiality of the partner data.

Various features and advantages of some embodiments are set forth in the following claims.

What is claimed is:

1. A system for annotated data collection in an electronic messaging platform, the system comprising:
a machine learning database;
an electronic processor communicatively coupled to the machine learning database, and configured to:
receive a plurality of electronic messages;
select a sample message set from the plurality of electronic messages;
add an actionable message to each electronic message of the sample message set;
receive an actionable message selection from an electronic messaging client, the actionable message selection including a user label indication and a message identifier; and
store the actionable message selection in the machine learning database.

2. The system of claim 1, wherein the electronic processor is further configured to:
select, from the plurality of electronic messages, a plurality of qualified electronic messages based on at least one qualifier; and
select the sample message set from the plurality of qualified electronic messages.

3. The system of claim 1, wherein the electronic processor is further configured to:
select a sample message set by selecting a random sample from the plurality of electronic messages.

4. The system of claim 1, wherein the electronic processor is further configured to:
select a sample message set based on a running total of stamped messages.

5. The system of claim 1, wherein the electronic processor is further configured to:
add an actionable message to each electronic message of the plurality of electronic messages; and
for each of the plurality of electronic messages, display the actionable message to a user of the electronic message when a total number of actionable messages presented does not exceed a desired sample number.

6. The system of claim 1, wherein the electronic processor is further configured to:
add an actionable message to each electronic message of the plurality of electronic messages; and
for each of the plurality of electronic messages, display the actionable message to a user of the electronic message when a total number of received actionable message selections does not exceed a desired collection number.

7. The system of claim 1, wherein the electronic processor is further configured to:
for each electronic message of the sample message set,
compare a time period since an actionable message was last presented to a recipient of the electronic message to a time gap enforcement threshold; and
when the time period does not exceed the time gap enforcement threshold, remove the electronic message from the sample message set.

8. The system of claim 1, wherein the electronic processor is further configured to:
receive a plurality of actionable message selections associated with a single message identifier; and
determine an aggregate label associated with the single message identifier.

9. The system of claim 1, wherein the electronic processor is further configured to:
receive a partner labeling request including a nudge message, at least one message label, and the at least one qualifier; and
wherein the actionable message includes the nudge message and the at least one message label.

10. The system of claim 1, wherein the electronic processor is further configured to:
receive, from a machine learning engine, a predicted label associated with a message identifier;
retrieve, from the machine learning database, the user label indication from the actionable message selection associated with the message identifier; and
compare the predicted label to the user label indication to generate a label quality level.

11. A method for annotated data collection in an electronic messaging platform, the method comprising:
receiving a plurality of electronic messages;
selecting, with an electronic processor, a plurality of qualified electronic messages from the plurality of electronic messages based on at least one qualifier;
selecting, with the electronic processor, a sample message set from the plurality of qualified electronic messages;
adding an actionable message to each electronic message of the sample message set;
receiving an actionable message selection from an electronic messaging client, the actionable message selection including a user label indication and a message identifier; and
storing the actionable message selection in a machine learning database communicatively coupled to the electronic messaging platform.

12. The method of claim 11, wherein selecting a sample message set includes selecting a random sample from the plurality of qualified electronic messages.

13. The method of claim 11, wherein selecting a sample message set includes selecting a sample message set based on a running total of stamped messages.

14. The method of claim 11, further comprising:
adding an actionable message to each electronic message of the plurality of electronic messages; and
for each of the plurality of electronic messages, displaying the actionable message to a user of the electronic message when a total number of actionable messages presented does not exceed a desired sample number.

15. The method of claim 11, further comprising:
adding an actionable message to each electronic message of the plurality of electronic messages; and
for each of the plurality of electronic messages, displaying the actionable message to a user of the electronic message when a total number of received actionable message selections does not exceed a desired collection number.

16. The method of claim 11, further comprising:
for each electronic message of the sample message set,
comparing a time period since an actionable message was last presented to a recipient of the electronic message to a time gap enforcement threshold; and
when the time period does not exceed the time gap enforcement threshold, removing the electronic message from the sample message set.

17. The method of claim 11, further comprising:
receiving a plurality of actionable message selections associated with a single message identifier; and
determining an aggregate label associated with the single message identifier.

18. The method of claim 11, further comprising:
receiving a partner labeling request including a nudge message, at least one message label, and the at least one qualifier; and
wherein the actionable message includes the nudge message and the at least one message label.

19. The method of claim 11, wherein the electronic processor is further configured to:
receiving, from a machine learning engine, a predicted label associated with a message identifier;
retrieving, from the machine learning database, the user label indication from the actionable message selection associated with the message identifier; and
comparing the predicted label to the user label indication to generate a label quality level.

20. A non-transitory computer-readable medium including instructions executable by an electronic processor to perform a set of functions, the set of functions comprising:
receiving a plurality of electronic messages;
selecting a plurality of qualified electronic messages from the plurality of electronic messages based on at least one qualifier;
selecting a sample message set from the plurality of qualified electronic messages;
adding an actionable message to each electronic message of the sample message set;
receiving an actionable message selection from an electronic messaging client, the actionable message selection including a user label indication and a message identifier; and
storing the actionable message selection in a machine learning database communicatively coupled to the electronic messaging platform.
